(19) United States
(12) Patent Application Publication
(10) Pub. No.: US 2026/0316116 A1
(43) Pub. Date: Oct. 15, 2026

(54) A TRANSDUCER AND A METHOD OF MANUFACTURING THEREOF, AND AN ULTRASOUND SCANNER

(71) Applicant: Nederlandse Organisatie voor toegepast-natuurwetenschappelijk onderzoek TNO, 's-Gravenhage (NL)

(72) Inventors: Paul Louis Maria Joseph VAN NEER, Bergschenhoek (NL); Egon Jacobus Wilhelmus MERKS-SWOLFS, Pijnacker (NL); Anne Maaike GERRITSMA, Rijswijk (NL); Quincy Edwin Vincent Nelson MARTINA, Pijnacker (NL)

(21) Appl. No.: 19/485,865

(22) PCT Filed: May 23, 2024
(86) PCT No.: PCT/NL2024/050264

§ 371 Date: Nov. 19, 2025

(30) Foreign Application Priority Data
May 23, 2023 (EP) 23174938.3

(51) Int. Cl. B06B 1/06

(52) U.S. Cl. CPC B06B 1/0692; B06B 1/0651

(57) ABSTRACT

The invention pertains to a transducer and a method of manufacturing thereof. The transducer is configured to emit and/or receive acoustical signals. The transducer includes a piezoelectric layer of homogeneous ceramic piezoelectric material sandwiched between a first and a second electrode. The first electrode, connectable to a higher voltage, covers a smaller area of the piezoelectric layer compared to the second electrode, connectable to a lower voltage or ground. The first electrode has an increased material coverage in the central region relative to the peripheral region of the piezoelectric layer.

### FIELD OF THE INVENTION

The invention relates to a transducer configured to emit and/or receive an acoustical signal, wherein the transducer comprises a homogeneous ceramic piezoelectric layer arranged between a first electrode and a second electrode. Additionally, the invention relates to a system comprising the transducer with said homogeneous ceramic piezoelectric layer. The invention also relates to a method for making a transducer including said homogeneous ceramic piezoelectric layer. Furthermore, the invention also relates to an ultrasound scanner, and the use thereof.

### BACKGROUND TO THE INVENTION

Acoustical transducers, and more particularly, piezoelectric acoustic transducers, are widely utilized in various applications, such as ultrasound imaging systems. In the piezoelectric acoustic transducers, piezoelectric materials undergo deformation in response to an applied voltage, resulting in the emission or reception of acoustical signals.

One of the persistent challenges in the design and application of homogeneous ceramic piezoelectric transducers is achieving optimal performance under various conditions, such as extreme ambient pressures and/or temperatures. A key factor influencing the performance of these devices is the design and configuration of the electrodes that interface with the piezoelectric layer. The design of the piezoelectric transducer may lead to detrimental beam shapes, which can result in more noise, reduced signal strength, and/or decreased overall performance. In various applications, there is a desire to obtain a narrow constant-amplitude beam profile. This is for example relevant in applications where the transducer must be housed within a confined space, such as in slimline boreholes.

Traditional methods for reducing beam width involve using specific layers or employing curved surfaces, such as concave or convex ones, to focus the beam better. Another approach is to use a lens system. However, these designs may not be suitable or too complex for certain applications with size constraints.

It is common in the prior art that beam narrowing is achieved through electronic control of linear array transducers or phased array transducers. These transducers are created by dividing the transducer surface into small areas, or array elements, and assigning each element a distinct function. A smooth curve function can be approximated due to the discrete reaction of the individual array elements. Electronic control techniques are applied to the design of the acoustic head. Again, the use of array transducers can be too complex for certain applications, or the transducer itself too fragile. When the application requires a single element transducer, instead of an array transducer with multiple elements, piezo composite materials form a possibly attractive alternative to homogeneous ceramic piezoelectric materials.

The use of piezo composites has a number of limitations and possibilities. On the one hand, like with the array transducers, the employment of a piezo composite allows for the attainment of a desired deflection through the adjustment of electrode shape, utilization of multiple electrodes, or alteration of polarity. Given the substantial stiffness disparity between the matrix material, namely epoxy, and the piezo material within the piezo composite, the intended deflection of the piezo material remains largely unaffected by the matrix material. This characteristic facilitates the prediction of a piezo composite-based design's behavior and the formulation of a design concept for a targeted performance. On the other hand, the pronounced discrepancy in material properties between the matrix material, specifically the epoxy, and the piezo material, results in significant variation in the thermal deflection coefficients of the two materials. This implies that substantial temperature disparities cause immense stress at the interfaces between the piezo material and the matrix material, i.e., the epoxy. If the temperature shifts are sufficiently large, it can induce plastic deformation, potentially leading to delamination and material failure. This rationale is also applicable in the context of considerable pressure differences. Piezo composites were initially conceived for the medical sector, which typically experiences maximum temperature variances of 5-10 degrees, thereby avoiding this issue. It is well-understood within the NDT applications field that piezo composites exhibit limited resistance to substantial temperature/pressure changes.

A certain type of ultrasonic borehole scanners optimized for operation in narrow pipes consist of the following key parts, which jointly form the acoustic head: an ultrasound transducer, an acoustic mirror and an acoustic window. The transducer is configured to produce a sound beam that is aimed along the axis of the borehole scanner/pipe. This orientation means that the long axis of the transducer is parallel to the axis of the borehole scanner, allowing for the smallest diameter device possible. The acoustic mirror is arranged to reflect the sound beam from an orientation parallel to the axis of the borehole scanner/pipe to an orientation perpendicular to the axis of the borehole scanner/pipe. The acoustic window is arranged to isolate the internals of the borehole scanner from the surrounding borehole liquid in the pipe. Typically the material choice and shape of the acoustic window is optimized such to minimize its effect on the sound beam. The broad beam produced by the ultrasound transducer (notably the ‘edge waves’) in combination with the configuration of the acoustic mirror and window design lead to a whole host of spurious reflections bouncing around in the acoustic head. These undesired reverberations pollute the desired pulse-echo reflection from the pipe wall and in fact are the primary limitation of the accuracy of the measurements which can be performed using the borehole scanner. It is desired to reduce acoustic reverberations and thus the induced acoustic interference.

Therefore, there is a need for improved piezoelectric transducer designs that address the challenges and limitations associated with conventional designs. There is a strong desire to improve the performance of the transducer under the demanding conditions, for example conditions typically encountered in downhole environments, for example in the context of inspecting small diameter pipes under high temperature and pressure differences

### SUMMARY OF THE INVENTION

It is an object of the invention to provide for a method and a system that obviates at least one of the above mentioned drawbacks.

Additionally or alternatively, it is an object of the invention to provide for an improved acoustic transducer and method of manufacturing thereof.

Additionally or alternatively, it is an object of the invention to improve the performance of the transducer.

Additionally or alternatively, it is an object of the invention to reduce undesirable acoustic effects, such as sidelobes and transverse modes of vibration

Thereto, the invention provides for a transducer configured to emit or receive an acoustical signal, wherein the transducer comprises a piezoelectric layer of homogeneous ceramic piezoelectric material arranged between a first electrode and a second electrode; wherein the first electrode is connectable to a higher voltage and the second electrode is connectable to a lower voltage or ground, or vice versa; wherein a first area of the piezoelectric layer covered by the first electrode is smaller than a second area of the piezoelectric layer covered by the second electrode. In some examples, the first electrode has an increased coverage of electrode material in a central region of the piezoelectric layer relative to a peripheral region of the piezoelectric layer.

The first electrode can be configured to cover a central region of the piezoelectric layer.

The invention provides for a significantly improved electrode configuration for the acoustic transducer. The transducer can effectively reduce undesirable acoustic effects, such as sidelobes and/or transverse modes of vibration. The design of the transducer serves to enhance the overall performance of the downhole tool by improving the quality and strength of the acoustic signals generated or received by the transducer.

The increased coverage of electrode material in the central region of the piezoelectric layer relative to the peripheral region further improves the transducer's performance by promoting uniform stress distribution and minimizing peripheral deformation. The piezoelectric layer and/or the electrodes may have different shapes and sizes to optimize the transducer's performance.

The transducer according to the disclosure does not employ piezo-composite materials. For piezo-composite transducers, the composite is filled with epoxy, which has high sensitivity to temperature and pressure, limiting its use in high-temperature and high-pressure applications. In order to effectively avoid the detrimental effects associated with the use of piezo-composite materials, thereby limiting the applicability of the transducer for various applications encountering relatively large temperature and/or pressure differences, the transducer according to the claimed invention is provided with a homogeneous ceramic piezo material. In the same line of reasoning, the disclosure also does not employ array transducers.

Utilizing a homogeneous piezo material does pose some technical challenges. This is due to the fact that altering the electrode shape, such as reducing the size of the hot electrode relative to the ground electrode, does not result in the intended deflection. Owing to the uniform stiffness of the piezo material, a significant restriction, or clamping, is imposed on the deflection by the modified electrode. This creates a substantial discrepancy between the anticipated and actual deflections.

Furthermore, the deflection at the edge of the piezo material, where the piezo layer is affixed to the housing, will never completely terminate at zero. This results in imperfect final apodization, leaving a step on the edge which leads to higher than desired sidelobe levels. This phenomenon can be attributed to the combined factors of the piezo layer's uniform stiffness, the high stiffness of the piezo material, and the comparatively low stiffness of the adhesive.

This observation is also relevant when smaller electrodes are used in conjunction with poling. Due to the disparity in the size of the hot and ground electrodes, the electric field lines do not all vertically pass through the piezo material. Consequently, the deflection profile that is actually achieved significantly diverges from the intended deflection.

Such factors contribute to the complexity in designing transducers that adhere to a particular behavior, particularly the deflection resulting from an imposed electrical excitation.

The invention obtains advantageous deflection apodization in order to mitigate the generation of sidelobes. The center of the piezoelectric element is allowed to move, but the movement of the outer edge (cf. peripheral region) is reduced.

Optionally, a clamping unit is arranged which is configured to provide a clamping action on at least a portion of the peripheral region of the piezoelectric layer.

This clamping unit serves to control the mechanical deformation of the piezoelectric layer, reducing the generation of sidelobes, reducing noise and/or increasing signal strength.

More particularly, the arrangement of the transducer can result in the reduction of unwanted sidelobes and -transverse modes of vibration, which increases the magnitude of the usable acoustic output for a given electrical input. This enhanced performance is achieved through the innovative clamping unit, which includes a clamping electrode arranged in the peripheral region of the piezoelectric layer. By precisely controlling the clamping forces on the piezoelectric layer, the clamping unit suppresses undesirable vibrations and mechanical stresses, resulting in a cleaner and stronger acoustic signal. This improvement in signal quality enables more accurate and reliable measurements in ultrasound scanning applications.

This effect of reducing unwanted sidelobes and transverse modes of vibration is important for several reasons. Firstly, it can improve the overall accuracy and reliability of the ultrasound scanning measurements. By suppressing undesirable vibrations and mechanical stresses, the transducer generates cleaner and stronger acoustic signals, enabling more precise detection and analysis of features, defects, or changes in the scanned medium. Additionally, this effect can play a significant role in expanding the range of applications for ultrasound scanning technology. With an improved signal-to-noise ratio and enhanced performance, the ultrasound scanner can be utilized in more challenging and demanding scenarios, such as inspecting slimline boreholes, evaluating high-temperature or high-pressure conditions, or detecting small defects in complex structures. This increased versatility and adaptability of the ultrasound scanner make it a valuable tool across various industries, such as for example medical diagnostics, oil and gas exploration, infrastructure inspection, etc.

Optionally, the clamping action provided by the clamping unit comprises a mechanical clamping, an electrical clamping by means of piezoelectric actuation, or a combination thereof. The electrical clamping may also be understood as a piezoelectric clamping.

Various clamping unit designs may be employed, such as mechanical clamps or electromagnetic clamps, to achieve the desired clamping action.

It will be appreciated that the peripheral region may be defined functionally, in terms of its function in the operation of the transducer. For example, it can be defined as the region of the piezoelectric layer that is primarily responsible for clamping or other secondary functions, rather than the primary function of emitting or receiving acoustical signals.

Optionally, the clamping unit includes a clamping electrode arranged in the peripheral region.

Advantageously, an improved clamping can be obtained. The presence of the clamping electrode further enhances the transducer's performance by allowing precise control of the clamping action and reducing undesirable mechanical stresses. Alternative embodiments may feature different clamping electrode designs, such as segmented, annular electrodes, etc., to optimize the clamping action and achieve the desired performance characteristics.

A continuous spacing gap can be provided between the first electrode and the clamping electrode, and wherein the spacing gap is uninterrupted by any additional electrodes positioned between the clamping electrode and the first electrode.

The first electrode, smaller and centered, covers the central region of the piezoelectric layer, while a larger second electrode covers a more extensive area. This configuration enables focused excitation or detection at the center, improving the transducer's efficiency by reducing lateral resonance effects in the piezo material. Additionally, a clamping electrode, situated in the peripheral region with a continuous spacing gap from the first electrode, ensures mechanical stability without interfering with the acoustic functionality. This structural arrangement prevents any detrimental overlap that might affect the transducer's performance, thereby optimizing both the mechanical and acoustic properties.

The transducer may have a configuration where the piezoelectric layer positioned between two electrodes exhibits differential area coverage. The first electrode, e.g. connected to a higher voltage, may cover a smaller (central) region compared to the second electrode. The inclusion of a clamping unit with a clamping electrode in the peripheral region, separated from the first electrode by a continuous spacing gap uninterrupted by any other electrodes, can effectively reduce undesirable acoustic effects, such as sidelobes and/or transverse modes of vibration. The design of the transducer serves to enhance the overall performance of the tool by improving the quality and strength of the acoustic signals generated or received by the transducer. A more uniform stress distribution and reduced peripheral deformation can be obtained. Additionally, detrimental effects of the clamping to the actuation by means of the first electrode connected to the piezoelectric layer can be reduced.

The configuration of the transducer can have a continuous spacing gap between the first electrode, centrally located, and the clamping electrode, positioned in the outer or peripheral region, which is uninterrupted by any intermediate electrodes. This uninterrupted gap can prevent any overlap or interference between the electrical fields and mechanical forces emanating from the respective electrodes. Experimental data and modeling simulations have shown that this separation ensures that the electrical and mechanical interactions remain distinct and localized to their respective regions. This arrangement effectively prevents any potential adverse effects on the transducer's performance that might arise from unwanted coupling or interference between these forces, thereby maintaining optimal functionality and enhancing the overall efficacy and reliability of the acoustic signal generation and reception. Such arrangement of the electrodes and the maintenance of a clear spacing gap contribute significantly to the robustness and precision of the transducer in its operational environment.

Optionally, the clamping electrode has an annular design.

This design allows for a uniform distribution of clamping forces around the periphery of the piezoelectric layer, minimizing mechanical stresses and enhancing the overall performance of the transducer. Alternative embodiments may include other annular designs, such as concentric rings or a combination of segmented and annular electrodes, to optimize the clamping action and transducer performance.

Optionally, the peripheral region is exclusively reserved for electrodes or mechanisms intended for clamping instead of active acoustic functionalities.

The reserved peripheral region for clamping mechanisms enhances the structural integrity of the transducer. By dedicating this area exclusively for non-acoustic functions, such as mechanical clamping obtained using the clamping electrode, there is a reduction in the interference of mechanical elements with the acoustic signal generation and reception. This separation optimizes the transducer's overall acoustic clarity and output by ensuring that only the central area is utilized for its primary functional purposes, thus effectively segregating mechanical and acoustic components to their optimal operational zones.

By isolating the mechanical clamping from the acoustic signal generation and reception areas, the transducer can achieve higher fidelity and stability in its operation.

Optionally, the use of the clamping electrode for the active generation or reception of acoustical signals is precluded.

By precluding the use of the clamping electrode for acoustic signal generation or reception, the invention ensures that the mechanical stability provided by the clamping does not compromise the acoustic performance. This design choice minimizes cross-talk and potential distortion in signal output by ensuring that the clamping electrode solely serves a structural purpose, thereby enhancing the quality and reliability of the acoustic signals produced or received by the transducer.

Optionally, the diameter of the first electrode is at least 30% of the diameter of the second electrode, and wherein the diameter of the first electrode does not exceed the diameter of the second electrode minus two times the thickness of the piezoelectric layer.

The specified diameter of the first electrode relative to the second electrode ensures an optimal balance between the electrode coverage and the effective acoustic field. With the first electrode's diameter being at least 30% but not exceeding the second electrode's diameter minus twice the piezoelectric layer's thickness, the design achieves a focused and efficient acoustic signal generation and reception, while minimizing unwanted lateral resonances. This proportionate scaling enhances the pressure-per-volt efficiency of the transducer.

Optionally, a width of the spacing gap between the first electrode and the clamping electrode is at least equal to the thickness of the piezoelectric layer and at most 70% of the diameter of the second electrode minus the thickness of the piezoelectric layer.

The width of the spacing gap between the first electrode and the clamping electrode, being at least equal to the thickness of the piezoelectric layer and not exceeding 70% of the diameter of the second electrode minus the thickness of the piezoelectric layer, provides sufficient isolation between the electrodes. This spacing minimizes electrical interference and mechanical stress transfer, thus enhancing the transducer's operational stability and signal integrity.

Optionally, a width of the clamping electrode is at least equal to a thickness of the piezoelectric layer and at most 70% of a diameter of the second electrode minus the thickness of the piezoelectric layer.

The design parameters for the clamping electrode's width, which is proportionately aligned with the thickness of the piezoelectric layer and the diameter of the second electrode, ensure effective clamping without compromising the transducer's structural integrity or its acoustic performance. These dimensions facilitate robust mechanical support while maintaining optimal distance from the central acoustic activity area.

Optionally, a sum of the width of the first electrode, the width of the clamping electrode, and the width of the spacing gap, is at least equal to the diameter of the second electrode and at most equal to the width of the piezoelectric layer.

The cumulative width of the first electrode, the clamping electrode, and the spacing gap correlates directly with the second electrode's diameter, ensuring that the entire piezoelectric layer is utilized effectively. This arrangement allows for a balanced electrode configuration that maximizes the usable surface area while maintaining structural and functional integrity across the transducer.

Optionally, the ratio between the piezoelectric constants d31 and d33 is less than 0.4, preferably less than 0.3, even more preferably less than 0.15.

In this way, the ratio between the piezoelectric constants d31 and d33 can be chosen such that the generation of undesirable shear waves, which are waves oriented perpendicular to the primary motion direction, behaving as flexural waves, are mitigated. This phenomenon occurs even in regions of the piezoelectric material that are not covered by electrodes, causing the material to move in conjunction with these waves.

It has been experimentally and through simulations determined that when the transducer is configured such that the ratio of d31 to d33 is less than 0.4, preferably less than 0.3, and even more preferably less than 0.15, the transducer experiences reduced adverse effects from such shear waves. Consequently, if the ratio of the piezoelectric constants falls within the desired ranges, the detrimental effect of these shear waves is minimized.

The homogeneity of the piezoelectric material can ensure that the entire material plate moves uniformly, contributing to the effectiveness of the transducer. The selection of appropriate materials has proven important in achieving the desired transducer performance.

The piezoelectric constants d31 and d33 denote the axes of the piezoelectric material utilized. The d33 piezoelectric constant pertains to the thickness direction movement, indicating the axis along which electrons are activated, resulting in movement in the thickness direction. Conversely, the d31 constant pertains to the axis perpendicular to this, indicating that electron activation in the thickness direction induces lateral activation of the piezoelectric material.

By choosing the piezoelectric material such that d33 is significantly greater than d31, the invention ensures that the compressional waves, which are the primary desired waves, are stronger than the shear waves or lateral waves. This configuration reduces the adverse effects associated with shear waves. Empirical evidence and simulations have shown that maintaining the ratio preferably below 0.3, and ideally below 0.1, effectively minimizes these adverse effects, enhancing the transducer's performance.

Optionally, the piezoelectric layer comprises a corona-poled piezoelectric material, wherein the piezoelectric layer exhibits a non-uniform corona poling pattern corresponding to a desired electrode configuration, and wherein the non-uniform corona poling selectively enhances the piezoelectric properties of the material in regions covered by the first electrode.

The use of a corona-poled piezoelectric material with a non-uniform poling pattern, specifically configured to enhance regions under the first electrode, selectively improves the piezoelectric properties in those areas. This targeted enhancement optimizes the material's response to electrical stimuli, thereby increasing the efficiency and effectiveness of the acoustic signal generation and reception, tailored to the specific electrode configuration.

Optionally, the corona poling of the piezoelectric layer produces a specific shape in the piezoelectric material, such as a star shape, confining piezoelectric behavior to designated zones or areas.

The specific shaping of the piezoelectric material's poling, such as a star shape, confines piezoelectric behavior to designated zones or areas. This design enhances the transducer's functionality by focusing the piezoelectric response in desired patterns, which increases the precision and effectiveness of the acoustic output, tailoring it to specific application needs.

Optionally, a shape of the clamping electrode is based on a complementary shape of the first electrode or is at least partially based on an inverse of the shape of the first electrode.

The complementary or inverse shaping of the clamping electrode relative to the first electrode can ensure that the mechanical clamping does not interfere with the electrically active areas. This configuration preserves the integrity of the acoustically active zones by minimizing mechanical disturbances and optimizing the transducer's functional areas, thereby enhancing both the acoustic performance and structural stability of the device.

Optionally, the transducer is configured to keep the clamping electrode at a predetermined voltage for achieving the clamping action.

This configuration allows for greater control of the clamping forces applied to the piezoelectric layer, improving the transducer's performance and reducing unwanted mechanical stresses. Alternative embodiments may utilize different predetermined voltages or active voltage control to achieve optimal clamping action and transducer performance. In some advantageous embodiments, the electrical clamping is achieved passively (without an active control unit). This can make the design of the transducer significantly less complex.

Optionally, the predetermined voltage is selected to be 0V.

This selection simplifies the electrical configuration of the transducer and reduces power consumption while still achieving the desired clamping action. Alternative embodiments may employ other voltage values close to 0V or utilize a floating voltage reference to optimize the clamping action and transducer performance.

Optionally, the predetermined voltage is a biasing voltage different than 0V, wherein the transducer is configured to select the biasing voltage such that deflection of the edge of the piezoelectric layer during operation is minimized.

This configuration further improves the transducer's performance by reducing unwanted mechanical deformation and noise. Exemplary embodiments may utilize different biasing voltages, dynamic voltage control, or feedback mechanisms to optimize the clamping action and minimize edge deflection.

Optionally, the transducer is configured to short circuit the clamping electrode and the second electrode for achieving the clamping action.

This configuration simplifies the electrical connections and reduces power consumption while providing the desired clamping action. Exemplary embodiments may include additional switching elements, such as transistors or diodes, to control the short-circuiting action and optimize the clamping action and transducer performance.

The direct short-circuiting provides several advantages. Firstly, the necessity for external voltage sources is obviated. This can significantly simplify the electrical configuration by eliminating the need for additional voltage sources to achieve the clamping action. Secondly, the physical connection between the clamping electrode and the second electrode is greatly simplified. This connection can be achieved using a simple wire or other advantageous connection methods such as throughole vias, fold-over foils, electroplating, sputtering, flexible printed circuit boards, etc., thereby streamlining the assembly process and reducing potential points of failure associated with more complex electrical configurations. Thirdly, the potentials of both the clamping electrode and the second electrode are definitively established through the short circuit. This inherent stability precludes the need for meticulous adjustments that would otherwise be necessary if each electrode were connected to separate voltage sources. By obviating the requirement for precise voltage regulation between the electrodes, the transducer design is rendered more robust and reliable.

By implementing these improvements, the present invention offers a transducer with enhanced operational simplicity and reliability, while also reducing the complexity and cost associated with external power sources and intricate electrical connections. This can effectively ensure a more stable and efficient clamping action, thereby enhancing the overall performance of the piezoelectric transducer.

The clamping electrode and the second electrode can be configured to establish a short circuit for obtaining the clamping action. This short circuit can be characterized by an electrical resistance that is negligibly small. The term “negligibly small” in this context refers to the fact that the resistance in the short circuit is so low that it can be considered practically insignificant in the overall electrical behavior of the transducer. This condition may provide for an effective operation of the clamping unit, ensuring that the clamping electrode can result in an adequate clamping action.

When a negligibly small resistance is present, the electrical current can flow freely between the clamping electrode and the second electrode. This configuration can enhance the transducer's performance by allowing the clamping action to be achieved more effectively and reliably. It provides the needed electrical pathway for controlling the clamping action, which may be instrumental in optimizing the piezoelectric layer's performance by affecting how it vibrates or deforms under the influence of an electrical signal.

A short circuit with negligibly small resistance can be particularly beneficial in applications where rapid and precise control over the transducer's behavior is required. For example, in acoustical signal detection or emission applications, such a configuration can help maintain the accuracy and sensitivity of the transducer, leading to improved signal quality and reliability.

The negligibly small resistance in the short circuit between the clamping electrode and the second electrode can thus provide for an effective clamping action with a relatively simple design and thereby enhancing the overall performance of the transducer.

Optionally, the electrical resistance is less than a predetermined value, such as smaller than 10 Ohm, preferably smaller than 1 Ohm.

Optionally, the electrical resistance is smaller than a fraction of the lowest electrical impedance value of the piezoelectric material, for example smaller than 10%, more preferably smaller than 5%, even more preferably smaller than 1%.

Optionally, the clamping electrode is connectable to a ground potential for achieving the clamping action.

This configuration simplifies the electrical connections and reduces power consumption while still providing the desired clamping action. Exemplary embodiments may utilize different ground connections or employ voltage references other than ground to achieve the desired clamping action and optimize transducer performance.

Optionally, the clamping electrode is connectable to a clamping signal for achieving the clamping action.

This configuration enables precise control of the clamping forces applied to the piezoelectric layer, improving transducer performance and reducing the generation of potential sidelobes.

Optionally, the clamping signal is actively controlled.

In some examples, an active control of the clamping signal is performed, for example utilizing a controller. The controller may be adapted to actively reduce or minimize the deflection of the piezoelectric layer at or approximate the edges or peripheral regions. Exemplary embodiments may employ different active control techniques, such as feedback control, feedforward control, or adaptive control, to optimize the clamping action and enhance transducer performance.

Optionally, the clamping signal is based on an inversion of the actuation signal provided to the first electrode.

This configuration allows for precise control of the clamping forces, reducing unwanted noise or signal artefacts such as sidelobes and improving the overall performance of the transducer.

Optionally, the first electrode is shaped such that a free region is obtained that is not covered by the first electrode wherein the clamping unit is provided within said free region.

Advantageously, this configuration allows for obtaining an improved electrical clamping. Exemplary embodiments may include different shapes and sizes of the first electrode and various arrangements of the clamping unit within the free region(s) to optimize transducer performance.

Optionally, the clamping electrode is shaped to substantially cover said free region.

This design allows for a uniform distribution of clamping forces, and enhancing the overall performance of the transducer.

Optionally, the piezoelectric layer is selectively clamped. The piezoelectric layer may be clamped in preselected regions.

By clamping the piezoelectric layer in preselected regions, the transducer can optimize its performance by enhancing the generation and reception of acoustical signals, as well as suppressing unwanted vibrations.

The piezoelectric layer may have various shapes, such as round, rectangular, elliptical, or polygonal designs, depending on the specific requirements of the application.

Optionally, the piezoelectric layer is disc shaped. A disc-shaped piezoelectric layer offers several benefits, including uniform stress distribution and simplified fabrication processes. This shape also enables more efficient generation and reception of acoustical signals, contributing to improved performance and accuracy of the ultrasound scanner.

Optionally, the disc is unclamped in the middle. This design can lead to improved signal generation and reception, as well as more effective suppression of unwanted vibrations.

Optionally, the disc is clamped only at its outer (edge) regions. This configuration also simplifies the clamping process, minimizing the complexity of the transducer design.

Optionally, only an electrical actuation voltage is provided in a central region of the disc shaped piezoelectric layer, wherein at least a portion of the other regions of the piezoelectric layer is electrically clamped. The electrical clamping may for example be performed by short circuiting, or by applying a predetermined voltage to obtain a biasing effect.

By applying an electrical actuation voltage only in the central region of an e.g. disc-shaped piezoelectric layer, the transducer can achieve more precise control over the generation and reception of acoustical signals.

Optionally, separate electrodes are provided in the central region and the peripheral region of the piezoelectric layer, wherein the separate electrodes are configured to apply different voltages to the respective regions for selective electrical clamping of the piezoelectric layer.

Optionally, the separate electrodes in the central region and the peripheral region are connectable to different voltage sources, enabling independent control of voltages applied to each region.

Optionally, the transducer is configured for non-uniform surface excitation of the piezoelectric layer, wherein parts of the piezoelectric layer are clamped during operation.

Optionally, clamping of parts of the piezoelectric layer is achieved by selective activation or deactivation of electrodes in the respective clamped regions.

Optionally, the clamping is configured such that during operation, the peripheral region (e.g. an outer ring) of the piezoelectric layer remains substantially still. The electrical clamping may be performed with a biasing clamping actuation signal that is determined based on for example the geometry, material properties, and other relevant factors to determine the optimal voltage for maintaining the peripheral region of the piezoelectric layer piezoelectric layer substantially still during operation.

Optionally, the clamping unit is configured to provide for a frequency dependent clamping action.

Optionally, the clamping electrode is connectable via a network of discrete passive components.

This allows the electrical response of the clamping electrode to be modified or tuned by altering the characteristics of the passive component network. This could be used to adapt the behavior of the transducer for different operating conditions.

Optionally, the network of discrete passive components comprises at least one of a capacitor, an inductor, and a resistor.

The network of discrete passive components could include a variety of components, such as capacitors, resistors, or inductors, depending on the desired electrical response. These different types of passive components can alter the impedance seen by the clamping electrode, which can change how the clamping action responds to changes in the applied voltage. This can allow the transducer's performance to be optimized for specific operating conditions.

The passive component network could include combinations of capacitors, resistors, and inductors, which could allow a complex impedance to be achieved.

Optionally, the network of discrete passive components is configured such that the clamping action becomes frequency dependent.

This could allow the transducer to exhibit different behaviors at different frequencies, which could be used to adapt the transducer's performance for specific applications. This allows the transducer to function optimally across a broader range of operating conditions.

The network of discrete passive components could be configured such that the clamping action is stronger at higher frequencies, which could be useful in applications where high-frequency noise is a concern.

Optionally, frequency-dependent clamping action is configured to act as an electronic filter.

This can allow the transducer to reject or attenuate certain frequencies, which can be used to reduce noise or other unwanted signals. This can improve the quality of the output signal from the transducer by reducing unwanted frequencies.

The electronic filter could be a low-pass filter, a high-pass filter, or a band-pass filter, depending on the desired application.

Optionally, the electronic filter is an analogue electronic filter.

This can provide a smooth and continuous filtering effect across the frequency range, as opposed to digital filters which work with discrete values.

The analogue electronic filter could be designed with a range of different characteristics, depending on the desired filter performance.

According to an aspect, the invention provides for a method for making a transducer, wherein a piezoelectric layer of homogeneous ceramic piezoelectric material is provided arranged between a first electrode and a second electrode, wherein the first electrode is connectable to a higher voltage and the second electrode is connectable to a lower voltage or ground, or vice versa; and wherein a first area of the piezoelectric layer is covered by the first electrode and a second area of the piezoelectric layer is covered by the second electrode; wherein a clamping unit is provided which is configured to provide a clamping action on at least a portion of the peripheral region of the piezoelectric layer, wherein the clamping unit is provided with a clamping electrode arranged in the peripheral region, wherein a continuous spacing gap is provided between the central region of the first electrode and the clamping, and wherein the spacing gap is uninterrupted by any additional electrodes positioned between the clamping electrode and the first electrode.

In some examples, the first electrode has an increased coverage of electrode material in the central region of the piezoelectric layer relative to the peripheral region of the piezoelectric layer.

The first electrode is positioned centrally on the piezoelectric layer. The central location of the first electrode serves the primary function of the transducer, whether for emitting or receiving acoustic signals. The central placement is intended to focus and direct the acoustic energy more effectively. The clamping electrode is located in the peripheral or outer region of the piezoelectric layer. This clamping electrode's role is distinct from the central first electrode, involving the mechanical stabilization of the piezoelectric material. The continuous spacing gap that exists between the first electrode and the clamping electrode is uninterrupted by any additional electrodes, meaning there are no other conductive materials or structures bridging this space that could interfere with the functions of either the first or clamping electrodes. From experimental and modelling data it has been observed that the uninterrupted nature of the gap ensures that the electrical fields and mechanical forces generated by the first and clamping electrodes do not interact in ways that could compromise the transducer's performance.

Advantageously, the signal quality can be vastly improved. Reverberations can be reduced by a significant factor leading to a higher accuracy inspection result. In some cases, reverberations can be reduced by a factor of 10 or even more. A suppression of acoustic reverberation/spurious acoustic reflections can be achieved in an advantageous way, for example without the use of an additional acoustic window/mirror. For radially oriented transducers the diameter of the inspection tool will increase-there is a practical minimal length of the acoustical transducer at a particular frequency. In contrast, according to the invention, the transducer can be oriented along the axial direction of the pipe, thereby enabling its use for instance the inspection of small diameter pipes. Furthermore, the transducer is not only suitable for use in relatively small diameter piping, but it can also handle large temperature and pressure differences.

In some advantageous examples, apodization is obtained by means of electric clamping. For example, clamping electrodes at at least a part of the peripheral region can be used to reduce or minimize the piezoelectric layer there. When the deflection is very small or negligible, a near perfect apodization is obtained. In some examples, the clamping electrode includes an outer ring (cf. annular structure) arranged on the piezoelectric layer. This outer ring may for instance be electrically connected to the ground potential or 0V in order to hold it electrically at a deflection of 0, thereby reducing the generation of sidelobes. Moreover, as a result, the transducer is suitable for applications encountering large temperature differences and/or large pressure fluctuations.

Optionally, the first electrode and the second electrode are applied to the piezoelectric layer via a process of vapor deposition or sputtering, such that the electrodes are formed in a specific pattern. In certain examples, the pattern of the electrodes may be defined by selectively removing portions of the electrode material after deposition. This removal can be achieved through various techniques such as etching, milling, or other appropriate methods. This allows for the precise shaping of the electrodes and the creation of detailed structures on the piezoelectric layer, such as the creation of a smaller first electrode area in relation to the second electrode area, or the formation of an increased coverage of electrode material in the central region of the piezoelectric layer relative to the peripheral region. Such precision in electrode patterning can help improve the performance characteristics of the transducer, including its sensitivity and frequency response.

Optionally, the poling of the piezoelectric material can be performed either before or after the processing of the electrodes. Poling, a process which aligns the dipole moments within the piezoelectric material to enhance its piezoelectric properties, is typically carried out after the electrodes have been applied to the piezoelectric layer. However, it can occur either before or after the removal of electrode material to create the desired electrode pattern. One advantage of conducting the poling after the processing of the electrodes, including any removal of electrode material, is that the regions of the piezoelectric layer from which electrode material has been removed are not rendered piezoelectric during the poling process. This can be beneficial in applications where it is desirable to have areas of the transducer that do not exhibit piezoelectric properties. It also allows for precise control over the active piezoelectric regions of the transducer, thereby enhancing its performance and reliability.

Optionally, the piezoelectric material is poled using a process known as corona poling prior to the application of the electrodes. Corona poling is a technique where a high voltage is applied to a sharp electrode positioned close to, but not in contact with, the piezoelectric material, creating an ionized region or “corona” around the electrode. The strong electric field within the corona causes the dipole moments in the piezoelectric material to align, enhancing its piezoelectric properties. In particular, the corona poling can be conducted in a non-uniform manner, according to the desired electrode pattern. This non-uniform corona poling allows the piezoelectric properties of the material to be selectively enhanced in regions that will be covered by the electrodes, providing a high degree of control over the transducer's performance characteristics. This method can provide flexibility in the manufacturing process, as well as potential performance benefits depending on the specific requirements of the transducer application.

Material can be activated or polarized with a specific shape (e.g., star-shaped) to confine piezoelectric behavior to certain zones or areas. Applying a non-uniform poling provides important advantages. The non-uniform poling may involve poling with a voltage amplitude as function of radius equal to the apodization that is desired. Advantageously, the resulting transducer can have a fixed apodization independent of temperature or pressure.

By employing non-uniform corona poling, the material can be made locally piezoelectric, while surrounding areas remain non-piezoelectric (meaning they will not respond when a voltage is applied). It is desirable for the edges to remain stationary during operation. In the case of a star-shaped corona-poling pattern, the edges will still move due to the material's bending stiffness. To address this issue, electrical clamping methods may be employed utilizing clamping electrodes. The clamping electrodes may for example have an annular design. In some examples, the design of the clamping electrodes can mirror specific shapes, or alternatively, they can take the form of the inverse of these shapes. For instance, if the desired shape is a star, the clamping electrodes can either be star-shaped or they can adopt a pattern that corresponds to the negative space of a star. This essentially means that instead of the electrode resembling the star itself, it would take the form of the space around the star.

Furthermore, it is also possible to reverse the polarity in these negatively formed designs. In other words, where the original shape had a certain electrical charge distribution, the inverse shape will have its charge distribution flipped. This provides flexibility in terms of how the electrical properties of the clamping electrodes are managed, enabling a wider range of applications and uses.

According to an aspect, the invention provides for an ultrasound scanner including a transducer according to the disclosure.

This integration results in an ultrasound scanner with enhanced performance characteristics due to the improved transducer design. Alternative embodiments may include different types of ultrasound scanners, such as portable devices, stationary machines, or downhole tools with specialized housings, designed to accommodate the transducer configurations according to the disclosure.

Advantageously, the transducer according to the disclosure can be used in an acoustic/ultrasound head for small diameter downhole pipes suitable for high temperatures and pressures.

In some examples, the scan head is configured for use in a borehole with a diameter in a range of 5 cm to 50 cm. For example, the scan head may be dimensioned for use in a borehole with a diameter of around 20 cm.

In some examples, the scan head is dimensioned to pass through a narrow passage, for example with a diameter smaller than 10 cm, before deployment in a wider borehole.

Optionally, the scan head is sized to fit into slimline boreholes with a diameter of less than 10 cm, preferably less than 6 cm. In some examples, the scan head is sizes to fit into slimline boreholes with a diameter of less than 5 cm.

The design of the transducer can be made very small, even when clamping is employed. The compact design enables the ultrasound scanner to inspect and evaluate small diameter boreholes effectively, which may not be accessible using conventional downhole tools. The enhanced transducer performance further improves the quality and accuracy of the obtained data. Various exemplary embodiments may include various scan head designs and sizes, as well as different configurations of the transducer within the scan head, to optimize the performance of the ultrasound scanner in inspecting slimline boreholes under different downhole conditions, such as high temperature, pressure, and/or varying borehole geometries.

According to an aspect, the invention provides for a method for calibrating a transducer according to the disclosure, wherein the method involves determining a voltage used for electrical clamping at which the peripheral region of the piezoelectric layer remains substantially still, taking into account geometry, material properties, and other relevant factors.

It should be recognized that the definition of the peripheral region can be determined based on its functional role within the transducer's operational dynamics. For instance, the peripheral region can be characterized as the section of the piezoelectric layer that primarily contributes to auxiliary actions such as clamping, as opposed to the central role of generating or detecting acoustic signals. This functional distinction allows the peripheral region to accommodate secondary mechanisms that enhance the performance and reliability of the transducer, while the central region remains dedicated to the primary piezoelectric activity.

It will be appreciated that the peripheral region may refer to an outermost area of the piezoelectric layer. The definition of the peripheral region can depend on the specific shape and design of the piezoelectric layer, but generally, it can be understood as the area towards the edge of the layer, furthest from the center. For example, if the piezoelectric layer is a disc, the peripheral region can refer to a ring-shaped area at the outer edge of the disc.

In some examples, the peripheral region can also be referred to using alternative terms such as the “edge region”, “outer region”, or “boundary region” of the piezoelectric layer. These terms, like “peripheral region”, all refer to an area of the piezoelectric layer that is near or at its outer boundary, although the precise definitions of these areas can vary depending on the specific design and configuration of the transducer.

In some examples, the peripheral region can be defined based on the location of the clamping electrode. For instance, the peripheral region may be defined as the area of the piezoelectric layer that is covered by the clamping electrode and not by the first electrode. In this case, the specific dimensions of the peripheral region would depend on the sizes and shapes of the electrodes.

In some examples, the peripheral region may be defined more specifically by a certain width or percentage of the piezoelectric layer's diameter, such as the outermost 10% or 20% of the diameter.

In some examples, the peripheral region can be described in terms of its radial distance from the center of the piezoelectric layer. For instance, the peripheral region may be defined as the outermost 5%, 10% or some other fixed distance from the edge of the disc.

In some examples, the peripheral region can be defined relative to the placement and coverage of the first and second electrodes on the piezoelectric layer. For instance, the peripheral region may be considered as the area of the piezoelectric layer that is covered by the second electrode but not the first electrode. This can be a thin ring at the outer edge of the layer, or it can be a more substantial portion of the layer, depending on the relative sizes of the electrodes. For example, if the first electrode covers approximately 70% to 90% of the piezoelectric layer's diameter and the second electrode covers nearly the entire diameter, the peripheral region would then be the ring-shaped area representing the 10% to 30% of the diameter not covered by the first electrode.

It will be appreciated that any of the aspects, features and options described in view of the transducer and the system apply equally to the methods and the described ultrasound scanner. It will also be clear that any one or more of the above aspects, features and options can be combined.

### BRIEF DESCRIPTION OF THE DRAWING

The invention will further be elucidated on the basis of exemplary embodiments which are represented in a drawing. The exemplary embodiments are given by way of non-limitative illustration. It is noted that the figures are only schematic representations of embodiments of the invention that are given by way of non-limiting example.

In the drawing:

FIG. 1 shows a schematic diagram of an embodiment of a transducer;

FIGS. 2a, 2b show a schematic diagram of an embodiment of a transducer;

FIGS. 3a, 3b show a schematic diagram of an embodiment of a transducer;

FIGS. 4a, 4b, 4c show a schematic diagram of an embodiment of a transducer;

FIG. 5 shows a schematic diagram of an embodiment of an experimental setup;

FIG. 6 shows a schematic diagram of experimental results;

FIGS. 7a, 7b, 7c show a schematic diagram of experimental results;

FIGS. 8a, 8b, 8c show a schematic diagram of experimental results;

FIGS. 9a, 9b show a schematic diagram of experimental results;

FIG. 10 shows a schematic diagram of experimental results;

FIG. 11 shows a schematic diagram of experimental results;

FIG. 12 shows a schematic diagram of experimental results;

FIGS. 13a, 13b show a schematic diagram of experimental results; and

FIG. 14 shows a schematic diagram of an embodiment of an acoustic head.

### DETAILED DESCRIPTION

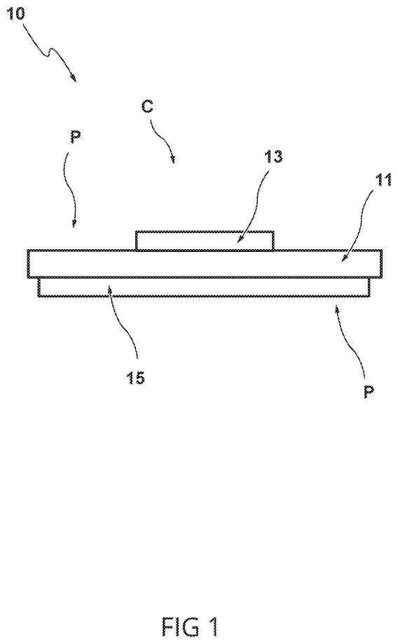

FIG. 1 shows a schematic diagram of a cross-sectional side view of an embodiment of a part of a transducer 10. The transducer 10 is configured to emit or receive an acoustical signal. The transducer 10 comprises a piezoelectric layer 11 of homogeneous ceramic piezoelectric material arranged between a first electrode 13 and a second electrode 15; wherein the first electrode 13 is connectable to a higher voltage and the second electrode 15 is connectable to a lower voltage or ground, or vice versa; wherein a first area of the piezoelectric layer 11 covered by the first electrode 13 is smaller than a second area of the piezoelectric layer 11 covered by the second electrode 15; and wherein the first electrode 13 has an increased coverage of electrode material in a central region C of the piezoelectric layer 11 relative to a peripheral region P of the piezoelectric layer 11. Significant improvement in the beam generated by the acoustic head can be achieved.

It will be appreciated that the relative dimensions shown may not accurately represent the actual design in practice (e.g., electrodes may have a considerably smaller relative thickness). Various configurations and arrangements are possible.

The improved transducer 10 can be employed for example in an acoustic head. Advantageously, unwanted reverberations can be avoided. The transducer design can effectively minimize internal reverberations in the acoustic head, which are usually caused by the complex geometry of the head and the edge waves/sidelobes produced by the transducer 10 in e.g. slim-line bore hole scanners. This allows for cleaner, less distorted signal collection.

Furthermore, an improved accuracy can be obtained by means of the improved transducer design. By eliminating undesired reverberations, the accuracy of certain algorithms, especially those that rely on low amplitude information such as trailing waves, is significantly improved. The transducer's performance is thus optimized.

The transducer 10 is effective in complex geometries. The transducer 10, due to its design, is capable of operating effectively even in the complex geometries of an acoustical head, including the acoustic mirror and window. Further, the transducer can reduce the impact of broad beams, which are a typical source of edge waves or sidelobes, further enhancing the quality and precision of its performance.

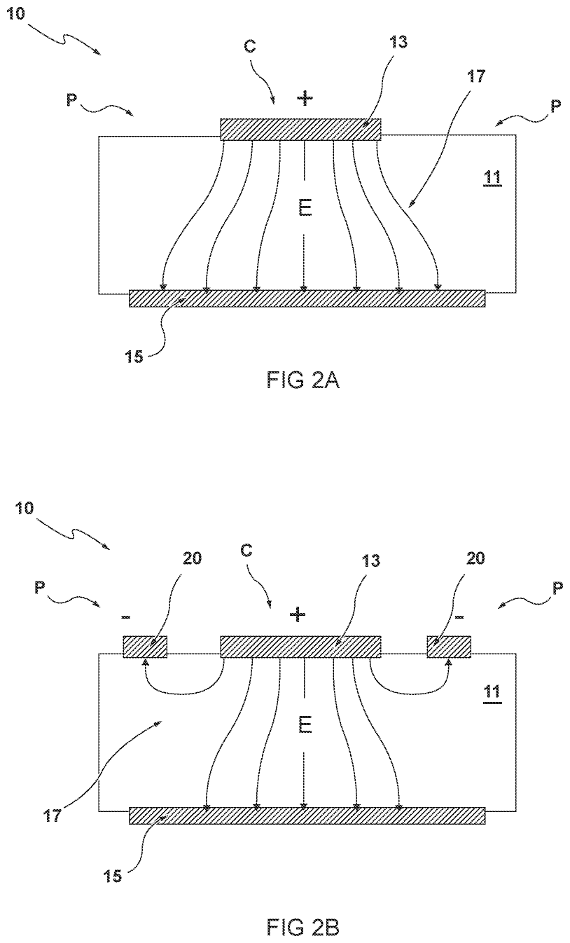

FIGS. 2a, 2b show a schematic diagram of a cross-sectional side view of an embodiment of a transducer 10. Advantageously, by making the active surface smaller, apodization can be achieved. The first electrode 13 has a smaller size than the second electrode 15. The second electrode 15 covers a significant portion of the piezoelectric layer. For instance, the second electrode 15 may cover an entire surface of the piezoelectric layer 11 on one side, whilst the first electrode 13 may cover only a portion of the piezoelectric layer 11 on the other side. The obtained electric field lines 17 between the first and second electrodes 13, 15 are illustrated. The electric fields 17 are perpendicular to the plane of the electrodes. At the edges, the electric field lines 17 will be curved.

Advantageously, an apodization effect is also achieved this way. The movement of the end portion (cf. peripheral region) of the piezoelectric layer 11 can be significantly reduced in this way. However, due to the lateral stiffness (bending stiffness), some movement will typically still occur. Although less than initially, experiments have shown that a relatively small movement may be observed.

In some examples, a clamping unit is arranged which is configured to provide a clamping action on at least a portion of the peripheral region P of the piezoelectric layer 11. In this way, a significantly improved apodization effect can be obtained. In some advantageous examples, an electrical clamping is employed on the side in order to reduce movement of the end portion (cf. peripheral region) of the piezoelectric layer. This is shown in the exemplary embodiment of FIG. 2b. The field lines near the edges are no longer present, and the material relies on its lateral bending stiffness. In this way, in an advantageous way, a non-uniform movement in the piezoelectric layer 11 can be achieved. Not all material is excited. Selective excitation can be employed in an effective way. The electrical clamping offers the potential to significantly enhance the beam characteristics. The electrical biasing enables the structure to achieve a different stiffness state. This can be achieved locally according to the invention using the electrical clamping.

In the exemplary embodiment of FIG. 2b, the clamping unit includes a clamping electrode 20 arranged in the peripheral region P.

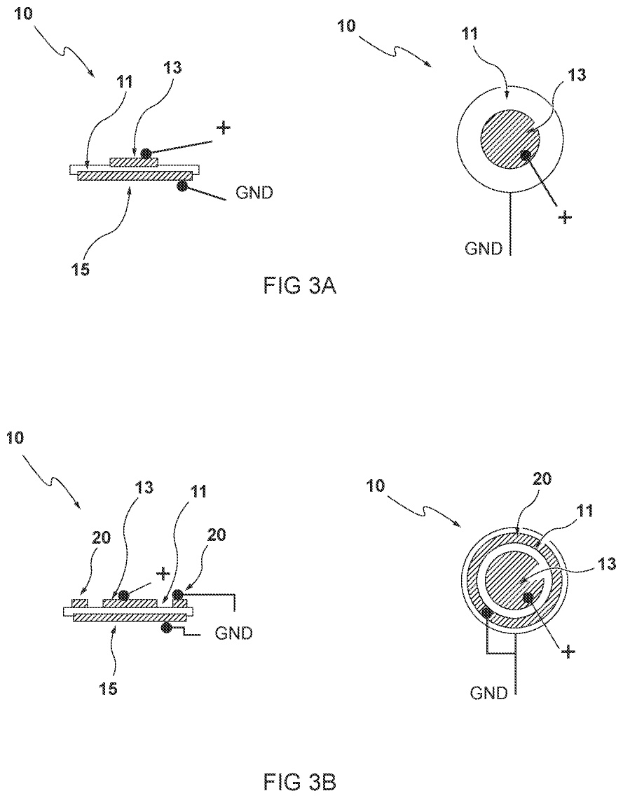

FIGS. 3a, 3b show a schematic diagram of an embodiment of a transducer 10. For each embodiment, a cross-sectional side view and a top view is shown. In the top view, it is clearly illustrated that the transducer has a disc-shaped design. However, various other shapes, arrangements and forms can be employed.

FIG. 3a shows an embodiment without an electrical clamping unit. FIG. 3b shows an embodiment with an electrical clamping unit. The transducer includes a homogeneous ceramic piezo material, wherein apodization has been achieved by means of electric clamping.

In the exemplary embodiment of FIG. 3b, the clamping electrode 20 has an annular design. However, various other clamping designs for achieving electrical clamping are envisaged.

Advantageously, the transducer can effectively generate a beam that induces less unwanted sidelobes and transverse modes of vibration in an acoustic head, thereby increasing the magnitude of the usable acoustic output for a given electrical input.

An electrical clamping can provide important advantages compared to mechanical clamping. For example, the mechanical clamping may involve clamping of the edge of the piezoelectric layer. At increased temperatures/pressures the piezo material will expand/contract, changing the effective clamping of the piezo. Thus this may work effectively at some temperatures but be less effective at other temperatures. This could also result in damage to the transducer. Hence, the design with mechanical clamping may be considered as less robust than the design with electrical clamping for some applications. Additionally or alternatively, the mechanical clamping may involve applying a glue (e.g. hard glue) on the sides of the piezo material. At increased temperatures the stiffness of the glue will typically be lowered. Therefore the clamping of the piezo material may change as a function of temperature. Thus, this design may be also less robust than the design with electrical clamping.

Therefore, the design with electrical clamping can improve the generated beam shape, suppressing sidelobes and/or edge waves to a large degree in an advantageous way. As a result, the transducer may be employed in acoustic heads with relatively large temperature/pressure fluctuations. For instance, the transducer may be robustly used in a borehole scanners that needs to work with large temperature and pressure variations (e.g. larger than 200 degrees Celsius temperature difference, and/or larger than 300 bar pressure differences).

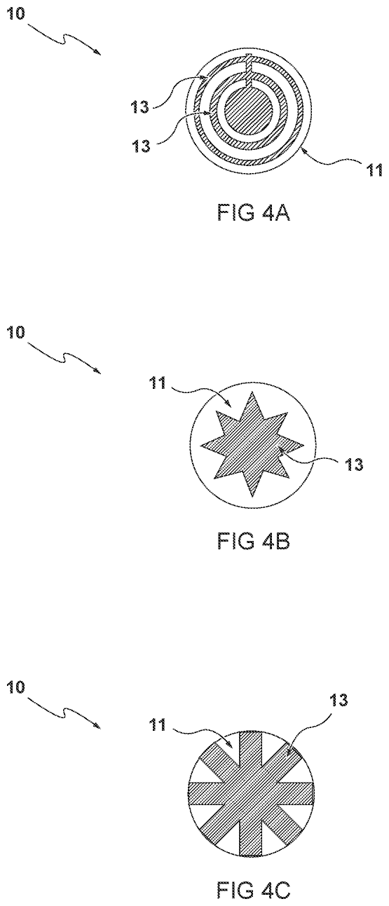

FIGS. 4a, 4b, 4c show a schematic diagram of top view of an embodiment of a transducer 10. The exemplary embodiments show different first electrode 13 designs. The first electrode 11 can have an increased coverage of electrode material in a central region of the piezoelectric layer 11 relative to a peripheral region of the piezoelectric layer 11.

The first electrodes 13 can be patterned such that the electrical field amplitude per unit area decreases with radius. Advantageously, the resulting transducer performance (acoustic field) can be less dependent of pressure and temperature.

Electrodes with distinct patterns can be effectively implemented, with a corresponding clamping. For example, a ‘flower-shaped electrode shape’ may be employed which is capable of delivering a near-uniform response. Advantageously, this can be integrated with a complementary figure designed to electronically clamp the spaces left vacant by the pattern. By pairing clamping with this approach brings several benefits. For example, it can help optimize the performance of the electrode by ensuring more effective control over the electric field distribution. This might result in a more stable, predictable behavior of the transducer.

This method enables the production of transducers with improved performance characteristics, particularly in terms of clamping action, electrode configuration, and efficient utilization of the piezoelectric material. Alternative embodiments may include different fabrication techniques.

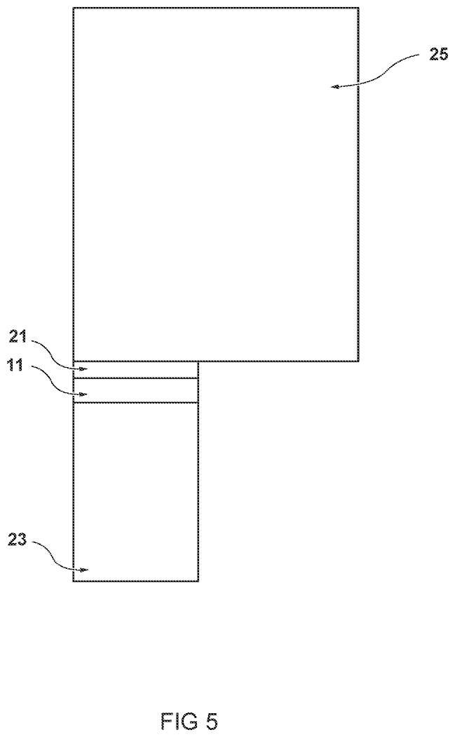

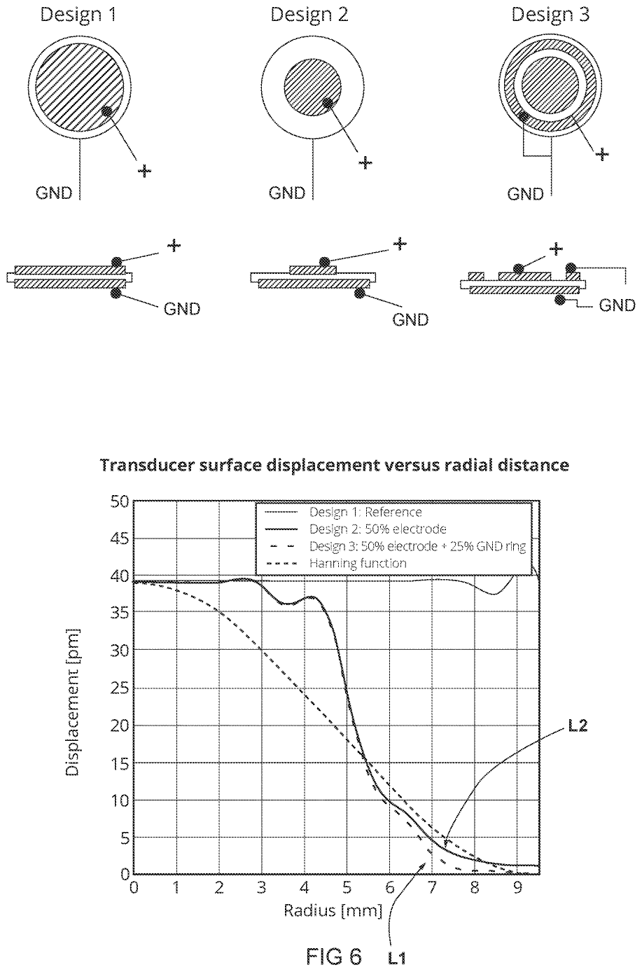

FIG. 5 shows a schematic diagram of an embodiment of an experimental setup. A piezoelectric layer 11 is connected to a matching layer 21 and a backing 23. Furthermore, the matching layer is connected to a medium layer 25, in this example water. This set-up has been used to test different transducer designs as illustrated in FIG. 6. The electrodes connected to the piezoelectric layer 11 are not shown in FIG. 5.

FIG. 6 shows a schematic diagram of experimental results. Three designs are shown, namely Design 1 (full transducer according to the prior art), Design 2 and Design 3.

Design 1 corresponds to the design known in the art. For example, in slim-line bore hole scanners, the complex geometry of the acoustical head (transducer, acoustic mirror, acoustic window) in combination with the edge waves/sidelobes (broad beam) produced by the transducer according to Design 1 typically leads to undesired reverberations inside the acoustic head. These reverberations strongly limit the accuracy of certain algorithms, particularly those based on low amplitude information (e.g. trailing waves). Design 2 and Design 3 provide for improved exemplary transducer designs according to the disclosure for overcoming the problems associated with Design 1.

Design 2 and Design 3 allow for effectively preventing or at least partially reducing the deflection across the entire width of the piezoelectric layer 11. Advantageously, a specific peripheral area of the piezoelectric layer will not be actively actuated. In Design 3, a clamping electrode ring has been arranged on the piezoelectric layer at or approximate the peripheral region. The ring is used to electrically clamp the peripheral region.

Applying a voltage to a piezoelectric material causes it to change in size. Holding the voltage at zero electrically clamps the material, even if there is an intention to move it mechanically. This clamping is possible through electrical actuation, i.e. “electrical clamping”. For instance, if the two electrodes are short-circuited (at 0V), they will counteract each other. This action will produce a force that prevents deformation, making the material harder and stiffer, which is sufficient for achieving the desired clamping effect.

By connecting the front and back in order to short circuit the clamping electrode with the second electrode 15, a 0V condition can be obtained. The approach is not limited to a short circuit; an active signal can also be applied (e.g., an inverted signal) to minimize deflection at the edges.

In some examples, electrical clamping can be further enhanced by applying a bias (bias/reverse signal), which strengthens the clamping effect. This improvement in clamping is substantial.

Additionally or alternatively, a counteraction can be provided when the material wants to expand (by putting it out of phase). This can be actively managed and is used in phased arrays (controlling beams with phases). Phased-array applications always involve separate elements. Using a reverse phase (reverse sine) can clamp the material (making it even stiffer) and achieve the apodization function. In this case, an opposite voltage (inverted signal) is used.

A 0V short circuit offers the advantage of a simple design without the need for additional hardware. When implementing control, however, additional hardware arrangements may be required, making the design more complex and possible less robust.

The graph shown in FIG. 6 displays deflection as a function of radius. The dotted line represents the desired function (in this example a Hanning function; cf. deflection under ideal conditions). The first line L1 and second line L2 indicate the difference between Design 2 and Design 3 (including electrical clamping). Design 3 can effectively achieve a negligible or measured zero deflection at the edge. Although the difference between line L1 and L2 at the maximum radius (i.e. end portion, cf. peripheral region) may seem relatively small, it has a significant impact on the results.

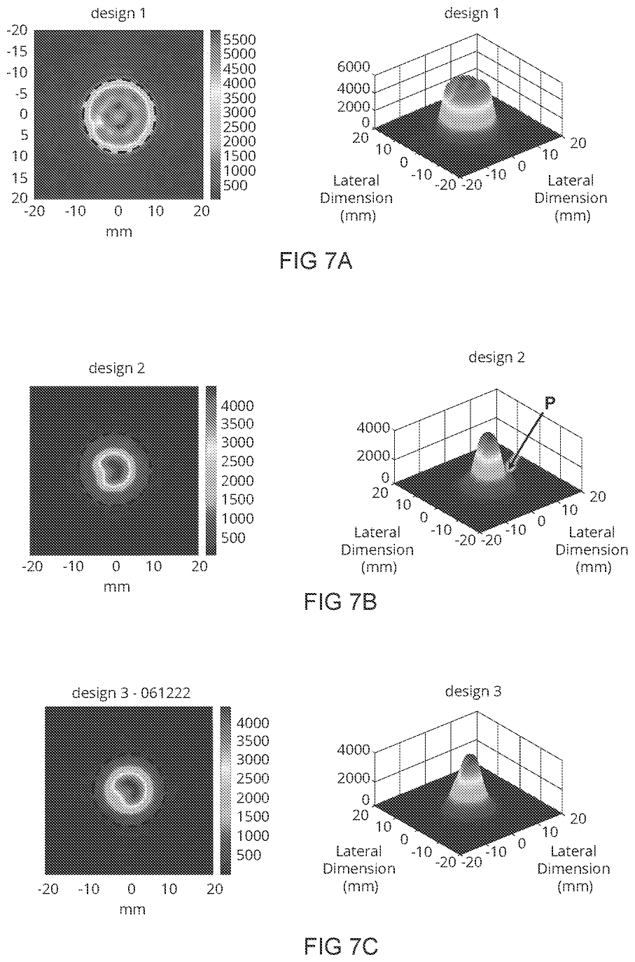

FIGS. 7a, 7b, 7c show a schematic diagram of experimental results for respectively Design 1, Design 2 and Design 3. The graphs are indicative of the beam shape. As can be seen, the beam shape in Design 2 and Design 3 is significantly improved. The generated beams by Design 2 and Design 3 are significantly narrower. For Design 2, a plateau-like portion P can be observed. For Design 3, such plateau-like portion is not present, resulting in a smoother shape.

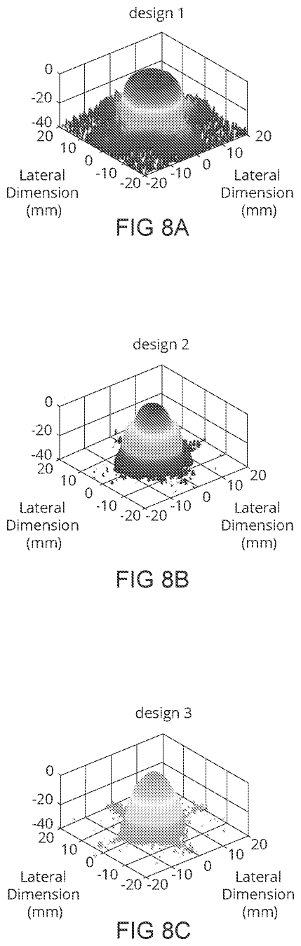

FIGS. 8a, 8b, 8c show a schematic diagram of further experimental results for respectively Design 1, Design 2 and Design 3. The data portrayed in FIG. 8 is identical to that of FIG. 7, however, it is depicted utilizing a logarithmic scale instead of a linear scale. Electronically clamping the material results in a significantly narrower beam, as confirmed by experiments. The top pattern is also less pronounced, leading to a more uniform beam.

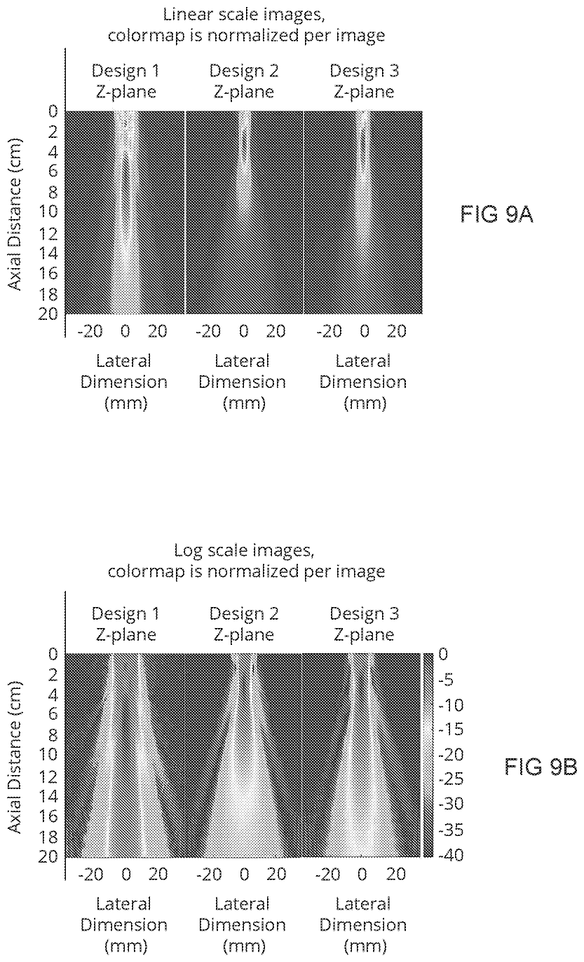

FIGS. 9a, 9b show a schematic diagram of experimental results for each of the three designs Design 1, Design 2 and Design 3. FIG. 9a illustrates linear scale images. A colormap normalization has been performed per image. FIG. 9b illustrates log scale images. Also here, a colormap normalization has been performed per image.

In Designs 2 and 3, the movement of the edges or peripheral regions of the piezoelectric layer (e.g., disc) can be reduced. This is achieved in an advantageous way, reducing the number or intensity of sidelobes due to the improved beam shape. Design 3 employs electrical clamping. It will be appreciated that mechanical clamping might be a solution also, but it presents additional challenges, such as making the edge very stiff or adding thickness. These adjustments may be difficult to execute for some applications. A hard adhesive layer is commonly used, but in this application, it is vulnerable. Electrical clamping can thus provide a significant benefit compared to mechanical clamping.

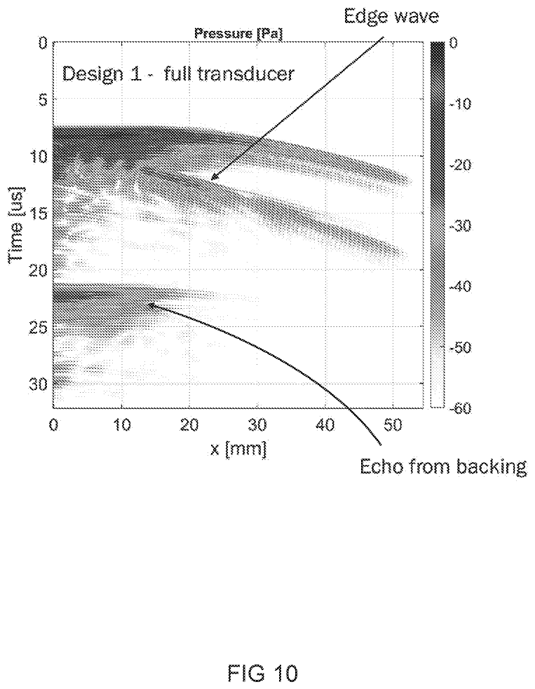

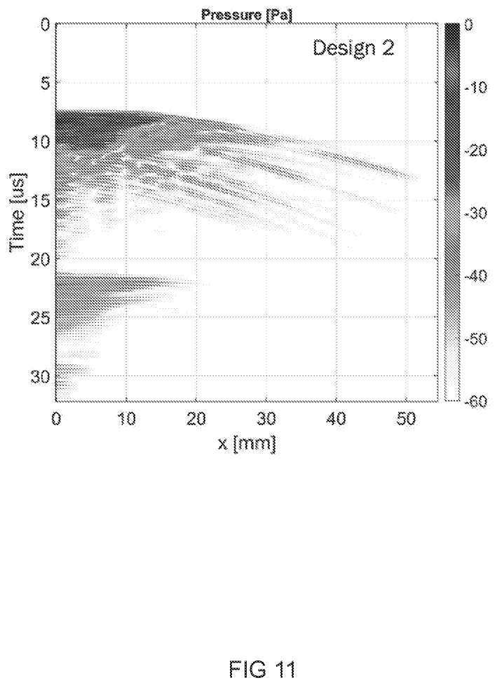

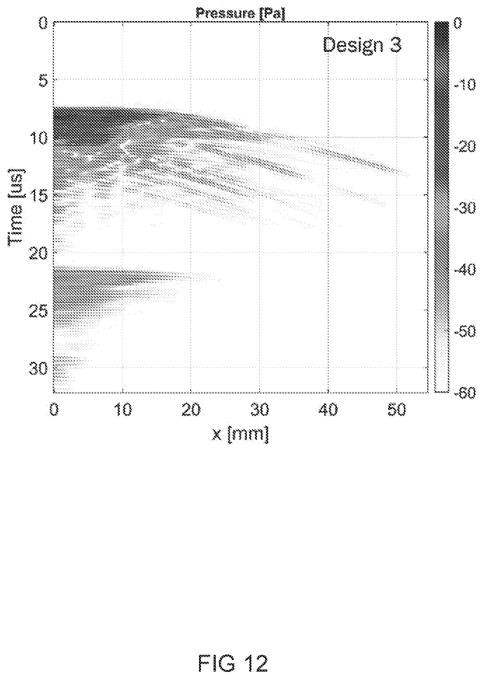

FIGS. 10, 11 and 12 show a schematic diagram of experimental results for respectively Design 1, Design 2 and Design 3. It can be seen that a significant improvement in the beam generated by the acoustic head can be achieved by utilizing the transducer according to the disclosure (Design 2 and Design 3). Furthermore, by clamping the edge of the ceramic piezoelectric material of the transducer using an electrical clamping, detrimental waves, spurious resonances, interfering echoes, etc. can be effectively reduced or suppressed, resulting in a significant increase of the acoustic efficiency of the transducer.

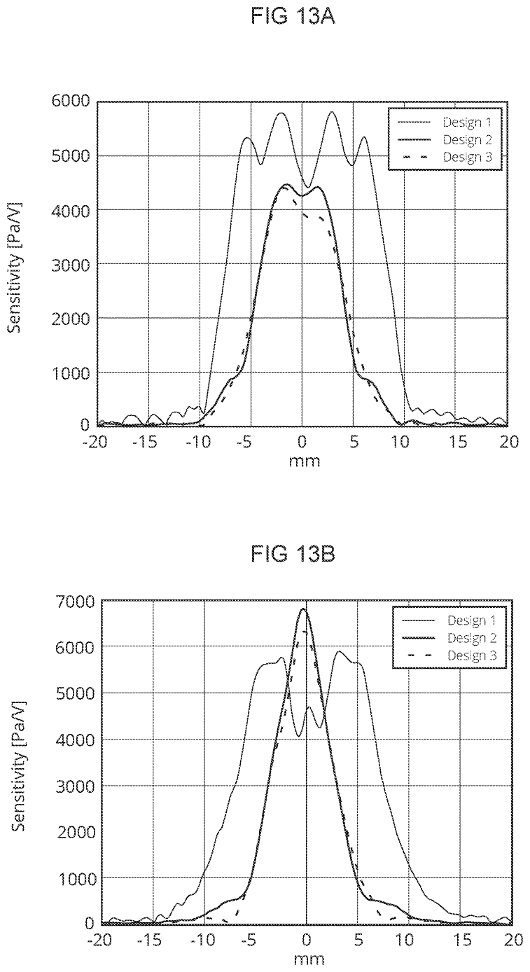

FIGS. 13a, 13b show a schematic diagram of experimental results for Design 1, Design 2 and Design 3. The graphs show the sensitivity (Pa/V) as function of the lateral location. FIG. 13a shows the response at transducer surface, and FIG. 13b shows a response at the mirror surface (at 22.5 mm in this example).

A challenge arises when a generated beam is too wide (cf. Design 1), leading to numerous reflections. By narrowing the beam (cf. Design 2 and Design 3), the angle of incidence is reduced, and shear waves that are prone to appear on any liquid-solid interface are less impacted.

The transducer according to the disclosure can be used in a broader range of applications, including those involving high temperature and high pressure. The designs can enhance the generated beam using an acoustic head with homogeneous ceramic material.

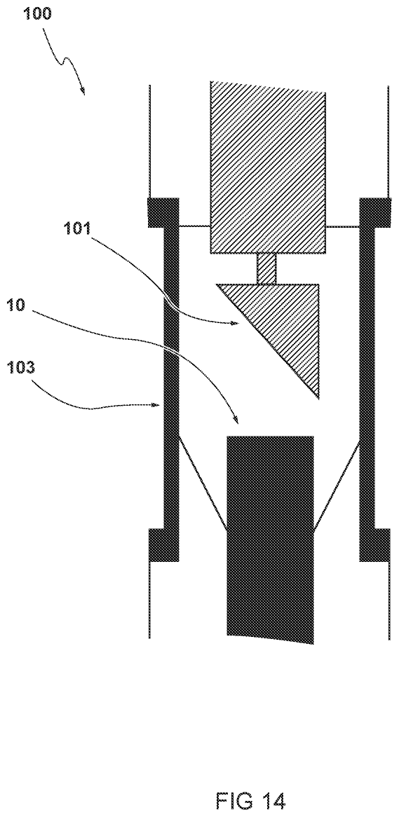

FIG. 14 shows a schematic diagram of an embodiment of an acoustic head 100 comprising the transducer 10 according to the disclosure. The acoustic head 100 is also usable for small diameter downhole pipes. Moreover, it can be applied even in conditions with large fluctuations in temperature and/or pressure. Some exemplary applications are ultrasonic inspection devices, borehole/downhole scanners, etc.

Advantageously, the transducer introduces an enhanced electrode configuration for an acoustic transducer, effectively minimizing unwanted acoustic effects and improving the signal quality and strength. The design encourages a uniform or even stress distribution and reduces peripheral deformation by increasing the electrode material's coverage in the piezoelectric layer's central region. The piezoelectric layer and electrodes can be of various shapes and sizes to optimize performance.

In this example, the acoustic head includes an acoustic mirror 101 and an acoustic window 103. The transducer 10 is configured to produce a sound beam that is aimed along the axis of the borehole scanner/pipe. This orientation means that the long axis of the transducer is parallel to the axis of the borehole scanner, allowing for the smallest diameter device possible. The acoustic mirror 101 is arranged to reflect the sound beam from an orientation parallel to the axis of the borehole scanner/pipe to an orientation perpendicular to the axis of the borehole scanner/pipe. The acoustic window 103 is arranged to isolate the internals of the borehole scanner from the surrounding borehole liquid in the pipe. Typically the material choice and shape of the acoustic window 103 is optimized such to minimize its effect on the sound beam. Advantageously, by means of the improved transducer design according to the disclosure, the generated beam can be improved and spurious reflections bouncing around in the acoustic head can be effectively reduced. As a result, the acoustic head 100 can generated less undesired reverberations that would otherwise pollute the desired pulse-echo reflection from the pipe wall. Advantageously, the accuracy of the measurements which can be performed using the acoustic head can be improved.

The present disclosure relates to a transducer capable of emitting or receiving acoustic signals in a variety of configurations and orientations concerning the piezoelectric layer and electrodes in relation to the overall structure of the transducer. The flexibility in the design of the transducer allows for the adaptation of its functionality according to specific application needs, thereby enabling different operational modes including varied emission and reception directions of the acoustic signals.

The disclosed transducer can be designed to function effectively regardless of the side from which the acoustic signal is emitted or received. This is achieved by structuring both sides of the transducer such that either can act as the emitting or receiving end. This dual functionality enhances the utility of the transducer across various acoustic applications, including but not limited to, medical imaging, sonar, and industrial non-destructive testing. Each side of the transducer, therefore, may be selected and/or capable for/of operating as an emitter or a receiver.

It will be appreciated that the transducer can be part of a transducer assembly, the transducer assembly for example having a backing, one or more matching layer(s) and a housing. The transducer may also be integrated in other devices, or be part of other types of assemblies.

It will be appreciated that various clamping techniques may be employed. Although numerous examples are given with respect to electrical clamping (i.e. employing a clamping electrode for performing piezoelectric clamping), it is also possible to employ mechanical or any other type of clamping such us using adhesive, glues or the like. Mechanical clamping is thus also envisaged. However, it is noted that at typical frequencies involved in the acoustic applications, the materials may act elastic. Clamping with a steel ring, for example, would still allow vibrations to pass through. High-stiffness adhesives could offer a solution; however, such adhesives typically cannot endure the temperatures and pressures encountered in this application. Thus, employing the electrical clamping according to the disclosure can provide significant advantages for various applications.

Various embodiments may be implemented using hardware elements, software elements, or a combination of both. Examples of hardware elements may include processors, microprocessors, circuits, application specific integrated circuits (ASIC), programmable logic devices (PLD), digital signal processors (DSP), field programmable gate array (FPGA), logic gates, registers, semiconductor device, microchips, chip sets, et cetera. Examples of software may include software components, programs, applications, computer programs, application programs, system programs, machine programs, operating system software, mobile apps, middleware, firmware, software modules, routines, subroutines, functions, computer implemented methods, procedures, software interfaces, application program interfaces (API), methods, instruction sets, computing code, computer code, et cetera.

Herein, the invention is described with reference to specific examples of embodiments of the invention. It will, however, be evident that various modifications, variations, alternatives and changes may be made therein, without departing from the essence of the invention. For the purpose of clarity and a concise description features are described herein as part of the same or separate embodiments, however, alternative embodiments having combinations of all or some of the features described in these separate embodiments are also envisaged and understood to fall within the framework of the invention as outlined by the claims. The specifications, figures and examples are, accordingly, to be regarded in an illustrative sense rather than in a restrictive sense. The invention is intended to embrace all alternatives, modifications and variations which fall within the scope of the appended claims. Further, many of the elements that are described are functional entities that may be implemented as discrete or distributed components or in conjunction with other components, in any suitable combination and location.

In the claims, any reference signs placed between parentheses shall not be construed as limiting the claim. The word ‘comprising’ does not exclude the presence of other features or steps than those listed in a claim. Furthermore, the words ‘a’ and ‘an’ shall not be construed as limited to ‘only one’, but instead are used to mean ‘at least one’, and do not exclude a plurality. The term “and/or” includes any and all combinations of one or more of the associated listed items. The mere fact that certain measures are recited in mutually different claims does not indicate that a combination of these measures cannot be used to an advantage.

1. A transducer configured to emit or receive an acoustical signal, wherein the transducer comprises:
a first electrode;
a second electrode; and
a piezoelectric layer of homogeneous ceramic piezoelectric material arranged between the first electrode and the second electrode;
wherein the first electrode is connectable to a higher voltage and the second electrode is connectable to a lower voltage or ground, or vice versa,
wherein a first area of the piezoelectric layer covered by the first electrode is smaller than a second area of the piezoelectric layer covered by the second electrode,
wherein the first electrode is configured to cover a central region of the piezoelectric layer,
wherein a clamping unit is arranged that is configured to provide a clamping action on at least a portion of a peripheral region of the piezoelectric layer,
wherein the clamping unit includes a clamping electrode arranged in the peripheral region,
wherein a continuous spacing gap is provided between the first electrode and the clamping electrode, and
wherein the spacing gap is uninterrupted by any additional electrodes positioned between the clamping electrode and the first electrode.

2. The transducer according to claim 1, wherein the peripheral region is reserved for electrodes or mechanisms intended for clamping and does not include active acoustic functionalities.

3. The transducer according to claim 1, wherein use of the clamping electrode for active generation or reception of acoustical signals is precluded.

4. The transducer according to claim 1, wherein a diameter of the first electrode is at least 30% of a diameter of the second electrode, and
wherein the diameter of the first electrode does not exceed the diameter of the second electrode minus two times a thickness of the piezoelectric layer.

5. The transducer according to claim 1, wherein a width of the spacing gap between the first electrode and the clamping electrode is:
at least equal to a thickness of the piezoelectric layer, and
at most 70% of a diameter of the second electrode minus the thickness of the piezoelectric layer.

6. The transducer according to claim 1, wherein a width of the clamping electrode is:
at least equal to a thickness of the piezoelectric layer, and
at most 70% of a diameter of the second electrode minus the thickness of the piezoelectric layer.

7. The transducer according to claim 1, wherein a sum of a width of the first electrode, a width of the clamping electrode, and a width of the spacing gap is:
at least equal to a diameter of the second electrode, and
at most equal to the width of the piezoelectric layer.

8. The transducer according to claim 1, wherein a ratio between the piezoelectric constants d31 and d33 is less than 0.4.

9. The transducer according to claim 1, wherein the piezoelectric layer comprises a corona-poled piezoelectric material,
wherein the piezoelectric layer exhibits a non-uniform corona poling pattern corresponding to a desired electrode configuration, and
wherein the non-uniform corona poling selectively enhances piezoelectric properties of the corona-poled piezoelectric material in regions covered by the first electrode.

10. The transducer according to claim 9, wherein corona poling of the piezoelectric layer resulting in the corona-poled piezoelectric material produces a specific shape in the piezoelectric material that confines piezoelectric behavior to designated zones or areas of the piezoelectric layer.

11. The transducer according to claim 9, wherein a shape of the clamping electrode is based on a complementary shape of the first electrode.

12. The transducer according to claim 1, wherein the transducer is configured to short circuit the clamping electrode and the second electrode for achieving the clamping action.

13. The transducer according to claim 1, wherein the clamping electrode is connectable to a ground potential for achieving the clamping action.

14. The transducer according to claim 1, wherein the clamping electrode is connectable to a clamping signal for achieving the clamping action,
wherein the clamping signal is actively controlled, and
wherein the clamping signal is based on an inversion of an actuation signal provided to the first electrode.

15. A method for making a transducer comprising, a first electrode, a second electrodes, and a piezoelectric layer of homogeneous ceramic piezoelectric material; the method including forming the transducer by arranging the piezoelectric layer between the first electrode and the second electrode,
wherein the first electrode is connectable to a higher voltage and the second electrode is connectable to a lower voltage or ground, or vice versa,
wherein a first area of the piezoelectric layer is covered by the first electrode and a second area of the piezoelectric layer is covered by the second electrode,
wherein the first electrode covers a central region of the piezoelectric layer,
wherein a clamping unit is provided which is configured to provide a clamping action on at least a portion of the peripheral region of the piezoelectric layer,
wherein the clamping unit is provided with a clamping electrode arranged in the peripheral region,
wherein a continuous spacing gap is provided between the central region of the first electrode and the clamping, and
wherein the spacing gap is uninterrupted by any additional electrodes positioned between the clamping electrode and the first electrode.

16. The method of claim 15, wherein the peripheral region is reserved for electrodes or mechanisms intended for clamping and does not include active acoustic functionalities.

17. The method of claim 15, wherein use of the clamping electrode for active generation or reception of acoustical signals is precluded.

18. The transducer according to claim 8, wherein the ratio between the piezoelectric constants d31 and d33 is less than 0.3.

19. The transducer according to claim 8, wherein the ratio between the piezoelectric constants d31 and d33 is less than 0.15.

20. The transducer according to claim 9, wherein a shape of the clamping electrode is partially based on an inverse of a shape of the first electrode.
